(19) United States
(12) Patent Application Publication
(10) Pub. No.: US 2003/0180965 A1
(43) Pub. Date: Sep. 25, 2003

(54) Micro-fluidic device and method of manufacturing and using the same

(76) Inventors: Levent Yobas, Shrewsbury, MA (US); Janet Kay Robertson, Easton, PA (US)

Correspondence Address: NIXON PEABODY, LLP, 8180 GREENSBORO DRIVE, SUITE 800, MCLEAN, VA, 22102, US

(21) Appl. No.: 10/150,007

(22) Filed: May 20, 2002

Related U.S. Application Data
(60) Provisional application No. 60/366,536, filed on Mar. 25, 2002.

(51) Int. Cl. G01N 1/10

(52) U.S. Cl. 436/180; 436/149; 436/150; 422/82.01; 422/100; 422/57

(57) ABSTRACT

A micro-fluidic device and a method for conducting various procedures with fluid. The device includes a substrate having a thickness direction and a substantially planar surface extending in a lengthwise direction that is substantially perpendicular to the thickness direction. A well is formed in the substrate to define a sidewall and a bottom surface. A channel having an internal surface is formed in the substrate below the substantially planar surface and extending substantially in the lengthwise direction. The channel is in communication with the well at one end thereof to define an orifice in the sidewall. Fluid in the well can be drawn into the orifice. As an example, the fluid can contain at least one cell which can be positioned against the orifice for a patch clamping procedure.

### RELATED APPLICATION DATA

This application claims benefit of provisional patent application Serial No. 60/366,536 filed Mar. 25, 2002 entitled “Micro-Fluidic Device And Method of Manufacturing And Using The Same”, the disclosure of which is incorporated here by reference in its entirety.

### FIELD OF THE INVENTION

The present invention relates generally to micro-fluidic devices. More particularly, the present invention relates to micro fluidic devices and methods of making and using a micro-fluidic device for biochemical activity analysis.

### BACKGROUND OF THE INVENTION

Microfluidic devices are commonly used for various purposes. For example the analysis and recording of activity from ion channels in biological cell membranes has been performed with micro-fluidic pipettes using a method that is commonly known as patch clamping. The patch clamp technique is an extremely powerful and versatile method for studying the electrophysiological properties of biological membranes. For example, the patch clamp technique is described in Single-Channel Recording, Second Edition edited by Bert Sakmann and Erwin Neher. The patch clamp technique has been adopted by numerous laboratories and has revolutionized research in both cellular and molecular biology. Accordingly, the patch clamp technique has become the method of choice in the investigation of cellular electrophysiology.

The patch clamp technique is an electrophysiological method for the recording of either macroscopic whole-cell or microscopic single-channel currents flowing across biological membranes via ion channels. The technique allows one to experimentally control and manipulate the voltage across either a membrane patch or an entire (whole) cell. This “voltage clamp” facilitates the study of the voltage dependence of ion channels. Alternatively, the changes in membrane potential in response to currents flowing across ion channels (current clamp) can be monitored. Such potential changes constitute the physiological response of a cell (e.g., action potentials). Other electrical parameters, such as the cell membrane capacitance, which is indicative of the plasma membrane surface area, can be monitored. Several variations of the patch-clamp technique have been developed including, “cell-attached”, “inside-out”, “outside-out”, and “whole-cell”.

Traditional “whole-cell” patch clamping begins with the fabrication of a glass micropipette with a 1- to 2-micrometer (μm) diameter tip opening. The micropipette is fabricated by heating the center of a glass capillary while pulling the ends of the capillary in opposite directions. Heating softens the glass while pulling stretches and tapers the capillary until the capillary separates into two pieces yielding two micropipettes. The micropipette is then filled with a salt solution and a silver (Ag) wire with a silver-chloride (AgCl) coating is inserted into the pipette solution to function as the pipette electrode.

In preparation for patch clamping, the micropipette tip is carefully positioned on the surface of a living cell while the cell and the pipette are observed with a microscope. Gentle suction is then applied through the pipette to draw a portion (a patch) of the membrane into the tip. The interior wall of the pipette immediately adjacent to the pipette orifice and the membrane patch form a mechanically and electrically tight junction, referred to as a “gigaseal” with an electrical resistance measured in the range of approximately 1 gigaohm (GΩ) to 100 GΩ. The gigaseal reduces or eliminates the leakage path that might otherwise exist between the cell membrane and the interior wall of the pipette.

In whole-cell patch clamping, the membrane patch surrounded by the gigaseal is then broken open without damaging the gigaseal to create a cell interior contiguous with the pipette solution. Using the Ag/AgCl wire inside the micropipette along with a second Ag/AgCl wire immersed in the solution surrounding the cell, an electrical current or voltage can be applied across the cell membrane. Both Ag/AgCl wires are directly connected to a negative feedback amplifier that supplies the current necessary to maintain the cell membrane potential at the pre-set command voltage (voltage clamp). This current, which can be measured and is equivalent to the net ion flow through the cell membrane, reveals valuable information about the functioning of the ion channels.

Many modern drugs act by affecting the operation of ion channels. The patch clamp test is the most powerful and direct approach known to interrogate ion channels and to validate the action of compounds targeting ion channels. However, the patch clamp technique suffers from several limitations which limit it's overall effectiveness and render its use impractical for the high throughput screening of drug candidates and other applications.

Traditional glass micropipettes have a large, typically greater than 1 MΩ, access resistance. The access resistance is the series resistance of the pipette fluid between the Ag/AgCl electrode and the center of the cell. The access resistance is primarily a function of the pipette tip geometry, the pipette shank length, and the degree to which debris from the broken cellular membrane patch occludes the tip opening. The access resistance limits the bandwidth of the recording system and can contribute to errors in the membrane potential. For low noise recordings, an access resistance of less than 1 MΩ is desirable. However for a typical micropipette geometry (1.2 μm diameter, 24° cone angle, 2 cm pipette length, 150 mM potassium chloride (KCl) solution) the access resistance is approximately 2.56 MΩ. Of this, about 1.26 MΩ is due to the conical tip, and approximately 1.3 MΩ is due to the cylindrical shank. To decrease the access resistance, the tip opening can be made larger and/or the shank can be made smaller. However, if the tip radius is increased, the rate of diffusion of compounds present inside the cell into the pipette will increase. This phenomenon is called “washout” and can lead to cell death. The minimum shank length is limited to that required for manual manipulation under a microscope.

Also, traditional glass micropipettes have a large pipette capacitance. The pipette capacitance is the capacitance between the pipette fluid and the fluid surrounding the exterior of the cell pipette. The pipette capacitance is distributed along the length of the pipette that is surrounded by the bath solution that contains the cells. Therefore, this capacitance can be difficult to eliminate electronically. In addition, dielectric relaxation of the pipette material may cause the pipette capacitance to drift as the measurement proceeds. The pipette capacitance may also limit the bandwidth of the recording system. Accordingly, to nullify the stray capacitance and associated noise, traditional glass micropipettes may need to be coated near their tips with an elastomer such as Sylgard™. The elastomer should be hydrophobic, non-conducting, low-loss, inert, nontoxic, easily applied and non-bleaching. The use of a coating increases the effective thickness of the pipette and the subsequent charge separation, thereby decreasing the pipette capacitance.

Only a limited set of materials can be used for pipette fabrication using the heat and pull method. Known such materials do not allow for the independent optimization of the access resistance, the pipette capacitance, and the system noise. Nor do known materials allow the tip material to be easily tailored to form good gigaseals with various cell lines.

Traditional glass micropipettes may need to be fire-polished to create a smooth tip and to burn off the fine film of elastomer coating. A smooth tip forms a seal with the cell membrane that is more stable than those accomplished by unpolished tips.

Traditional glass micropipettes contain a large volume of fluid. Thus when the cell is opened the contents of the interior of the cell diffuse out into the pipette (also referred to as washout) altering the physiology of the cell. Also, since the pipette and the bath both contain large (typically many times the cell volume) volumes of fluid, relatively large volumes of pharmaceuticals are needed when testing a cell.

It is also difficult to add fluid to, remove fluid from, or exchange the bath solution or the pipette solution in the conventional patch clamp setup. Rapid exchange of these solutions is desirable to allow pharmaceutical reagents to be introduced and dynamics of their effect on the cell at known concentrations to be accurately accessed.

The patch clamp test is a difficult and time-consuming procedure typically requiring a skilled scientist thus elevating the cost of patch clamp testing and severely limiting the number of patch clamp tests which can be performed daily with a given set of resources. Further, the patch clamp test using known apparatus requires large, heavy and expensive laboratory equipment, including sophisticated electronics to amplify and filter the patch clamp current. A typical patch clamp set up includes a vibration isolated table, a Faraday cage, remotely controlled micromanipulators, an inverted microscope, and a rack of sophisticated electronic equipment to amplify the picoampere (pA) currents and cancel fast and slow capacitive transients. The micropipette tip and the cell of interest are monitored through an inverted microscope with a 300 to 400-fold magnification and contrast enhancement. Electromagnetic shielding is provided by the Faraday cage, which surrounds the patch clamp setup. Amplification and recording of ionic signals is accomplished by sophisticated electronics. The first stage of amplification is integrated into the pipette holder. This “patch clamp tower” helps to reduce the amplifier noise by bringing the amplifier as close as possible to the signal source. The patch clamp electronics includes circuitry to compensate the capacitance at the headstage input, the capacitance of the pipette, and the capacitance of the pipette holder. During whole-cell recording, additional circuitry is employed to cancel the cell membrane capacitance. The patch clamp electronics also include filters, output gain stages, pipette offset cancellation, and current clamping.

Recently, semiconductor fabrication techniques have been used to form microelectro-mechanical systems (MEMS) for various fluid handling processes. For example, U.S. Pat. No. 6,063,589 discloses a microvalve mechanism manufactured using micropatterning processes. The resulting device can utilize the centripetal force resulting from rotation of a substrate to motivate fluid movement through microchannels. However, this patent does not address patch clamping applications and the device disclosed therein is not suitable for patch clamping procedures. In particular, this patent discloses a device for selectively causing fluid to flow between chambers and does not suggest formation of a gigaseal which prevents flow of fluid but is desirable for patch clamping procedures. U.S. Pat. No. 6,136,212 discloses the use of MEMS technology to create a subsurface channel that can be integrated with various micro-fluidic devices. However, this reference does not relate to patch clamping and thus fails to provide a device suitable for patch clamping processes. In particular, there is no mechanism disclosed in this patent by which a gigaseal can be formed.

MEMS devices have been used for patch clamping procedures. However, known MEMS devices for patch clamping are vertical devices. In particular, such devices use a hole in the substrate as a pipette orifice, the top surface of the substrate serves as the bath well, and the bottom surface of the substrate serves as a pipette well. During patch clamping, the cell moves in a direction perpendicular to the surface of the substrate. This arrangement overcomes some of the electrical limitations of conventional devices but does not truly automate patch clamping and facilitate the integration of other components on the substrate. Further, vertical devices are not readily adapted integration of plural devices and micro-fluidic components.

In view of the limitations above, it is desirable to provide a MEMS micropipette having a low access resistance and a low pipette capacitance. In addition, the micropipette should be easily integrated with desired fluidics and electronics. Most important, the micropipette should be able to automate patch clamping without the need for human intervention.

### SUMMARY OF THE INVENTION

The invention relates to a micro-fluidic device, such as a micro pipette, that is fabricated using semiconductor manufacturing techniques and is easily integrated with electronics and other components. On-chip microelectronics can be used to integrate low-noise amplifiers, electronic filters, analog-to-digital converters and other signal conditioning electronics near the signal source (the ion channels in the cell membrane) for optimal signal-to-noise ratio. On-chip microelectronics could also be used to integrate heaters and cooling devices for temperature regulation as well as sensors such as temperature and ion concentration sensors. On-chip microfluidics could preferably be used to exchange the bath and pipette solutions and to dispense pharmaceuticals or other compounds, while using extremely small (picoliter to microliter) volumes of fluid. The small volume of the micropipette helps to limit the “washout”. Small system volumes of fluid also reduce the amount of costly pharmaceutical reagents needed thus lowering the cost per test.

A first aspect of the invention is a micro-fluidic device adapted to accomplish a procedure using fluid. The device comprises a substrate having a thickness direction and a substantially planar surface extending in a lengthwise direction that is substantially perpendicular to the thickness direction, a well formed in said substrate and defining a sidewall and a bottom surface, a channel having an internal surface formed in said substrate below the substantially planar surface and extending substantially in said lengthwise direction. The channel is in communication with said well at one end of said channel to thereby define an orifice in said sidewall, whereby fluid in said well can be drawn into said orifice.

A second aspect of the invention is a method of manufacturing a micro-fluidic device adapted to accomplish a procedure using fluid. The method comprises forming a first trench having a bottom surface in the substrate, forming a first structural layer on the bottom surface, forming a sacrificial layer on the first structural layer, forming a second structural layer on the sacrificial layer, forming second and third trenches with at least a portion of the first structural layer, the second structural layer and the sacrificial layer extending therebetween, and removing the sacrificial layer to define a channel extending from the second trench to the third trench.

A third aspect of the invention is a method of manufacturing a micro-fluidic device adapted to accomplish a procedure using fluid. The method comprises forming a biocompatible layer on a substrate, forming an electrode on the biocompatible layer, forming a sacrificial layer over the electrode, forming at least one structural layer on the sacrificial layer, forming a first trench and a second trench in the substrate, said first trench having a sidewall defined at least by the structural layer and a bottom surface, and removing the sacrificial layer to define a channel providing communication between the first trench and the second trench and defining an orifice in the sidewall.

A fourth aspect of the invention is a method of moving biological cells to a desired position to facilitate performance of a procedure on the cells. The method comprises disposing a fluid ar least one biological cell in communication with a channel formed in a substrate, rotating said substrate about an axis to create a centripetal force directed toward the axis, permitting at least one of the plural cells to travel through the channel to be positioned against an orifice in response to the centripetal force.

A fifth aspect of the invention is a micro-fluidic device adapted to accomplish a procedure using fluid. The device comprises a rotational member, a body coupled to the rotational member to be rotated about a central portion thereof, a guiding channel formed in the body, means for introducing a fluid having at least one cell into the guiding channel at a first radial position with respect to the central portion, and a pipette orifice coupled to the guiding channel at a second radial position with respect to the central portion. The second radial position is further from the central portion than the first radial position, whereby rotation of the body about the central portion causes fluid in the guiding channel to flow towards the pipette orifice to thereby position the at least one cell against the orifice.

### BRIEF DESCRIPTION OF THE DRAWING

The invention is described through a preferred embodiment and the drawing in which:

FIGS. 1a-1g illustrate examples of the first preferred embodiment of the invention in which the orifice can be positioned independently of the well depth;

FIG. 2 illustrates a top view of a multiple pipette device in accordance with another preferred embodiment of the invention;

FIG. 3 illustrates a top view of a single bath well device in accordance with another preferred embodiment of the invention;

FIGS. 4a-4k illustrate the process steps for fabricating another embodiment of the invention;

FIG. 5 is a sectional view of the device fabricated by the steps of FIGS. 4a-4k and including a cover plate;

FIGS. 6a-6i illustrate the process steps for fabricating another preferred embodiment;

FIG. 7 is a perspective view of a device in accordance with another preferred embodiment;

FIGS. 8a-8c illustrate operation of another embodiment of the invention;

FIGS. 9a is a top view of another embodiment of the invention; and

FIG. 9b is a sectional view of the device of FIG. 9a.

### DETAILED DESCRIPTION

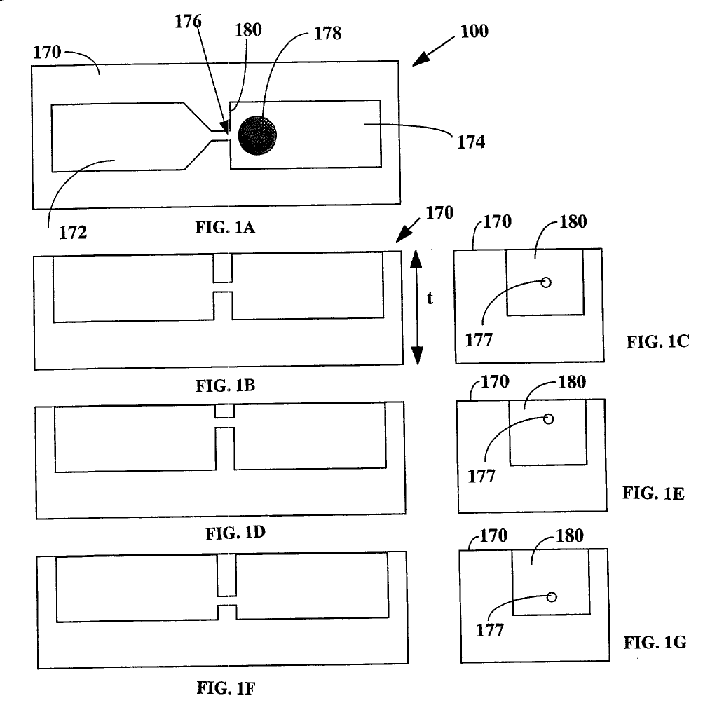

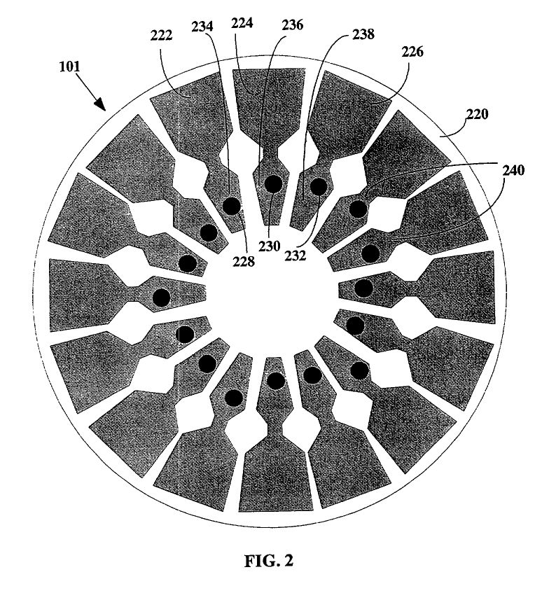

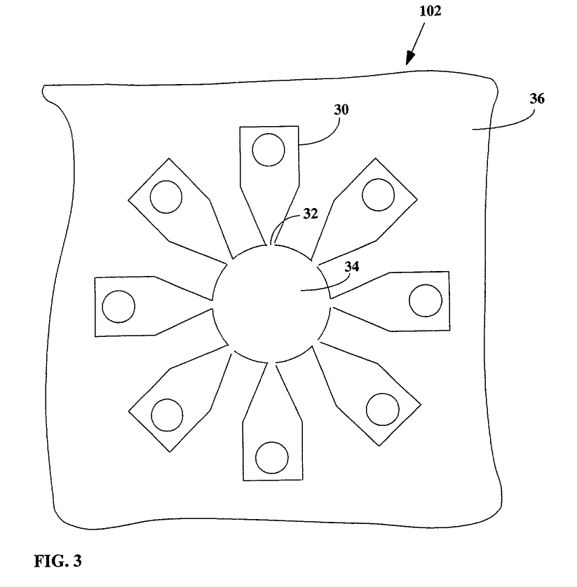

In accordance with a first embodiment of the invention, a pipette or capillary is integrated on a micro-fluidic device. FIG. 1a is a top sectional view of microfluidic device 100 including substrate 170. Two trenches have been formed in substrate 170 to define wells. Recess 172 is referred to herein as the pipette well. Recess 174 is referred to herein as the bath well. Pipette well 172 and bath well 174 can be formed by etching substrate 170, by depositing material on the surface of substrate 170, or by using a combination of these two techniques, as described in detail below.

Pipette well 172 and the bath well 174 are connected by sub-surface channel 176 formed in substrate 170. Channel 176 defines orifice 177 in wall 180 of bath well 174 as best illustrated in FIG. 1c. Pipette well 172, channel 176 and orifice 177 together define an integrated pipette. Orifice 177 is typically about 0.5 μm to 3 μm in diameter, although other diameters are possible. For example, orifice 177 can have a diameter in the range of less than 0.5 μm to 100 μm. A typical cell has a diameter of about 20 μm. When a force, such as a force resulting from hydrostatic pressure or centripetal force is applied to cell 178, which has been previously placed into the bath well, cell 178 is driven toward orifice 177. When cell 178 contacts portions of wall 180 surrounding orifice 177, a small portion of the membrane of cell 178 will be gently forced into channel 176 through orifice 177. Then the exterior of the membrane of cell 178 will contact the interior of channel 176 near orifice 177 thus forming a gigaseal.

Micro-fluidic device 100 can facilitate rapid manipulation of a living cell or other biological material by subjecting the cell to a centripetal force. The horizontal pipette described above is formed on the surface of substrate 170 and extends substantially perpendicular to the thickness direction t of substrate 170. Therefore, one or multiple pipettes can easily be fabricated in a radial pattern as shown in FIG. 2. In such an arrangement, the substrate can be rotated about a central portion to thereby use centripetal force to act as a centrifuge and move fluids radially outward in a desired manner. Further, while orifice 177 is defined in wall 180 at substantially a central portion thereof, the relative location of channel 176 and bath well 174 can be adjusted to define orifice 177 at any desired position of wall 180, such as an upper portion of wall 180 as illustrated in FIGS. 1d and 1e illustrating a modification of the first preferred embodiment, or a lower portion of wall 180 as illustrated in FIGS. 1f and 1g illustrating another modification of the first preferred embodiment. The location of orifice 177 can be determined independently of the dimensions of bath well 174.

In micro fluidic device 101 of FIG. 2, multiple micropipettes are integrated on one microdevice. In particular, as illustrated in FIG. 2, substrate 220, in the form of a disk, includes plural pipettes, such as pipettes 222, 224 and 226, integrated thereon. Cells, such as cells 228, 230 and 232 are located in respective bath wells 234, 236 and 238 etched into or formed on substrate 220. As micro-fluidic device 101 is rotated about its center of symmetry, a centripetal force acting towards, the center is generated. As a result of a differential of centripetal force acting on the fluid and the cell, each cell is propelled outward by an apparent centrifugal force until it is stopped by the orifice, for example any of those indicated by 240, between the respective bath well and pipette. In other words, the device acts as a centrifuge. Other operations of micro-fluidic device 101 are similar to micro-fluidic device 100 described above.

Each horizontal pipette extends outward, toward the exterior edge of micro-fluidic device 101, from the respective bath well and orifice. When a cell is lodged against an orifice, and a gigaseal is formed between the cell and the orifice, the interior of the pipette and the respective bath well reservoir will be substantially electrically and chemically isolated. If the cell is not positioned correctly, suction can be applied through the pipette to draw the cell toward the pipette orifice. This suction can be applied while the device is rotating or after the device has stopped rotating. Suction can also be applied to simply aid in the formation of the gigaseal if the action of the centrifuge positioned the cell correctly against the pipette orifice, but the gigaseal did not form. Suction can be further applied to break open the cell membrane that is surrounded by the gigaseal to attain the required configuration of the whole-cell patch-clamp.

The plurality of pipettes enables multiple independent patch clamp tests to be simultaneously performed. Each test can utilize independent voltage clamping or currently current clamping waveforms (or protocols). Each test can also utilize different chemical compounds such as drug candidates. Thus the integration of multiple pipettes on a single device facilitates the use of this micro device in high throughput screening.

FIG. 3 illustrates another micro-fluidic device 102 having multiple pipettes 30 integrated on a single substrate 36. This embodiment consists of a common central bath well 34 into which the cells are initially dispensed. Centrifugal force, applied by spinning device 102 about its central portion, propels the cells outward toward the pipette orifices 32 (only one of which is labeled in FIG. 3). As each cell contacts an orifice a small portion of the membrane is drawn into the pipette. This membrane “patch” forms a “gigaseal” with the interior surface of the pipette near the pipette orifice. Other aspects of device 102 are similar to device 101 and device 100.

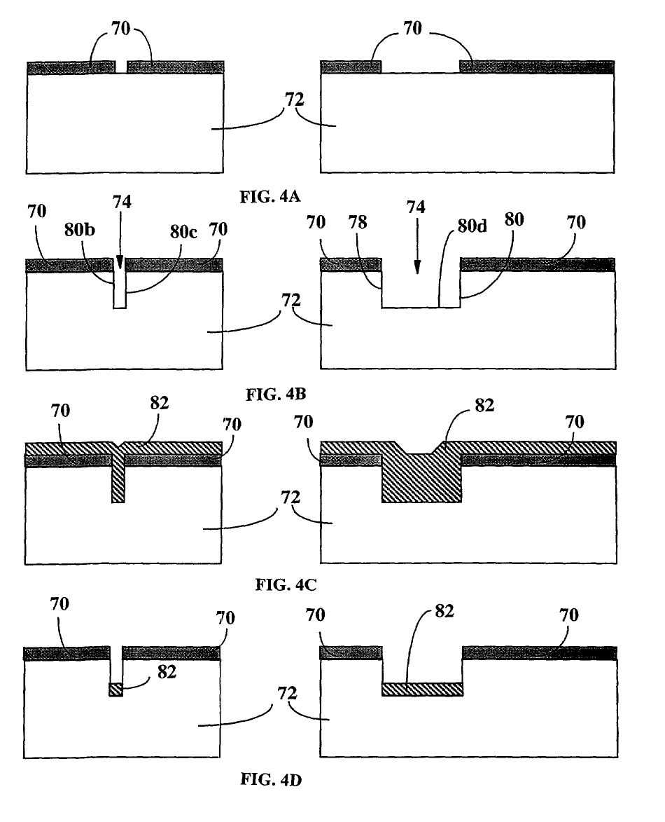

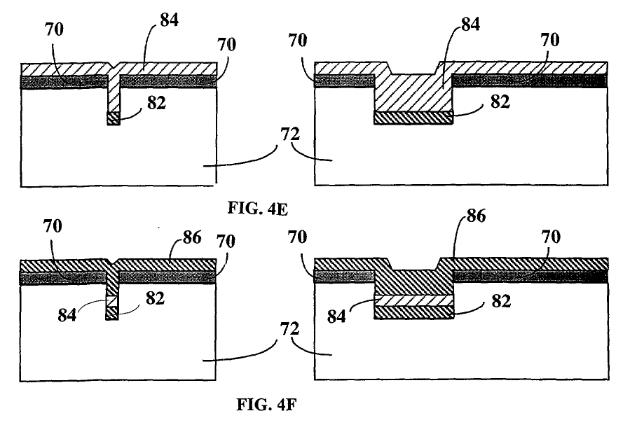

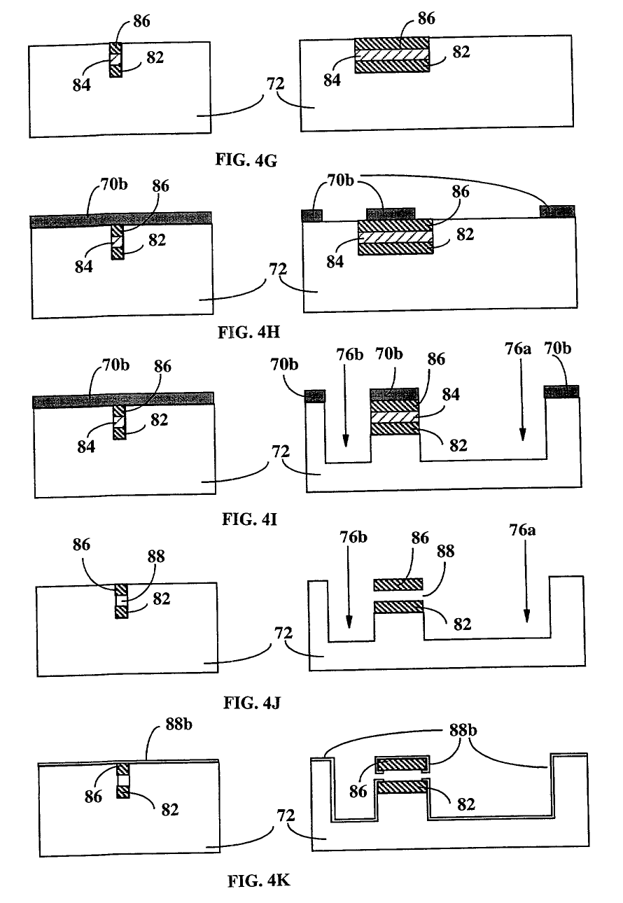

FIGS. 4a through 4k illustrate a method of fabricating a micro-fluidic device, such as device 100 illustrated in FIGS. 1a through 1g. Each of FIGS. 4a through 4k includes both a front view of the pipette in cross-section (left column) and a side view of the in pipette cross-section (right column). Referring to FIG. 4a, a thin film of masking layer 70 is deposited (or grown) on substrate 72 and patterned to expose areas of substrate 72. Preferably, substrate 72 is made of silicon, another typical semiconductor substrate material, glass, or another non-conducting material. The exposed areas of substrate 72 are etched or otherwise removed to create well 74 with substantially vertical side walls 78, 80, 80b, and 80c and a bottom surface 80d as illustrated in FIG. 4b. This step can be accomplished using a dry etching process, such as reactive ion etching (RIE). A wet etching process, such as potassium hydroxide (KOH) (or another orientation dependent etching process), can also be used if substrate 72 is silicon.

The fabrication continues with the deposition or growth of structural layer 82 (FIG. 4c) to fill well 74. Structural layer 82 is then etched to leave a thin film adjacent to surface as illustrated in FIG. 4d. Preferably, structural layer 82 is made of silicon dioxide (SiO₂), although other nonconductive or substantially nonconductive materials such as silicon nitride (Si₃N₄) or oxynitrides may be used. The oxide may optionally be grown in a high temperature furnace if the substrate is silicon. Alternately, SiO₂ can be deposited using low pressure chemical vapor deposition (LPCVD), plasma-enhanced chemical vapor deposition (PECVD), or by other integrated circuit manufacturing techniques. If grown or deposited using a conformal deposition process such as LPCVD, the SiO₂ layer will preferably uniformly coat all surfaces on which it is grown or deposited. If uniformly deposited or grown, the etch step may not be needed.

The selective removal of structural layer 82 may be accomplished using a dry etching process such as reactive ion etching (RIE) or a wet etching process such as buffered hydrofluoric acid (BHF). The “deposition and etch” cycle is repeated with sacrificial material 84 (FIGS. 4e and 4f. The sacrificial layer is preferably comprised of polycrystalline silicon, although other sacrificial materials such as a variety of metals or polymers may be used. Within well 74, the thickness of the remaining sacrificial material determines the height of the pipette orifice and the width of the remaining sacrificial material determines the width of the pipette orifice as will become apparent below.

A second structural layer 86 is then deposited or grown (FIG. 4f). The second structural layer is then removed until the surface of the silicon is substantially planar (FIG. 4g). This can be accomplished using chemical mechanical polishing (CMP) or using other integrated circuit fabrication planarization techniques.

A second masking layer 70b is then deposited and patterned (FIG. 4h) to expose areas of the device surface. The exposed areas are then etched forming wells 76a and 76b (FIG. 4i). Well 76a will become the bath well, and well 76b will become the pipette well. The remaining portion of sacrificial layer 84 is then removed (FIG. 4j) creating the channel and defining the pipette orifice 88. The sacrificial layer can be removed using either wet or dry etching. For example, if the sacrificial layer is polycrystalline silicon it can be removed using KOH, ethylene diamine pyrocatechol (EDP) or another silicon etchant. If the sacrificial layer is a polymer, such as photo resist, it can be removed using acetone.

Following the removal of sacrificial layer 84 to form orifice 88, the interior surface of the pipette and the walls of wells 76a and 76b can be coated with a biocompatible material such as SiO₂. If substrate 72 is silicon, this can be accomplished by growing a thin film of SiO₂. Alternately, parylene or another material which can be used to uniformly coat the interior of the channel can be used. Indeed, many alternate fabrication techniques can be used to ensure that all or substantially all surfaces exposed to biological material are biocompatible. Lastly, as shown in FIG. 4k, layer 88b, made of a material having an affinity to cell membranes, can be deposited to coat portions of wall 78 and the channel proximate orifice 88 to enhance the formation of the gigaseal between the pipette orifice and the cell membrane. An optional cover plate may be bonded to the surface of the device. The cover plate can cover the wells and can be made of glass or another non-conducting transparent material.

Other components may be integrated onto substrate 72 with the pipette, pipette well and bath well. These components may include, for example, signal conditioning electronics such as LEDs, low-noise amplifiers, digital-to-analog converters, electronic filters, etc. These components may also include micromechanical devices such as micropumps, microvalves, microheaters and microactuators. Further combination of these components may facilitate integration of patch clamping with more sophisticated Microsystems such as capillary electrophoresis (CE) and/or polymerase chain reaction (PCR). A variety of sensors could also be integrated with the pipette. These might include temperature sensors, humidity sensors, photodiodes (light sensors) and ion sensitive field effect transistors. In other words, since the integrated pipette is formed on the surface of the device, and since at the step illustrated in FIG. 4g the surface is planar, the fabrication of the integrated pipette can be interrupted at this point and other traditional devices also fabricated on the same substrate. The other devices can be masked to protect them during the etching processes. The fabrication of the pipette, pipette well and bath well would then continue, resulting in the possible integration of a wide variety of components to perform a wide variety of functions.

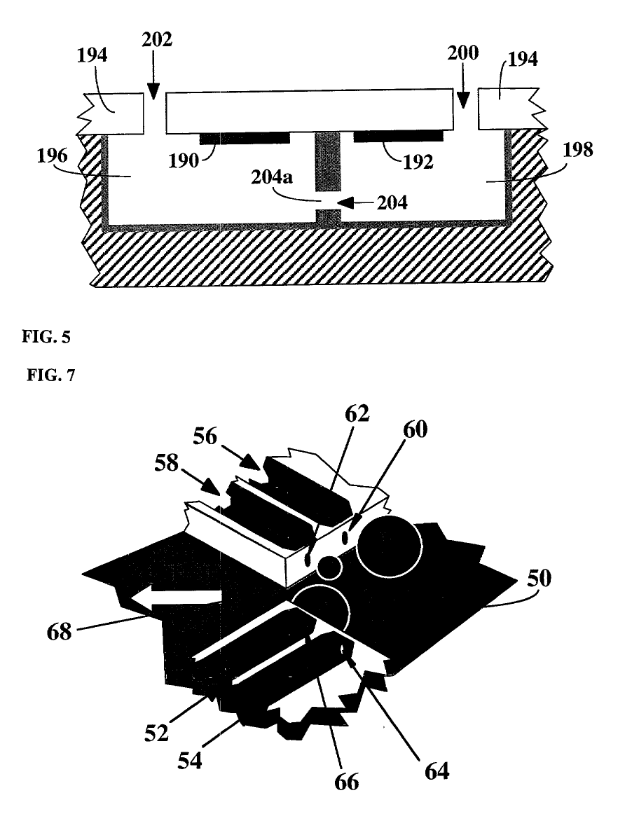

FIG. 5 illustrates the device shown in FIGS. 4a through 4k where electrodes 190 and 192, comprised of Ag/AgCl or another conductive material, have been integrated on cover plate 194. The electrodes are used in patch clamping. The integrated electrodes facilitate the detection of small picoampere currents which flow across the cell membrane and/or the application of bias or potential across the cell membrane. The material used to fabricate the electrodes should be able to exchange ions with the fluid in the well and must not change cell and ion channel physiology. Cover plate 194 is attached or bonded to substrate 72. If used, cover plate 194 is preferably comprised of glass and should seal tightly to substrate 72. Electrode 190 is in electrical contact with the fluid in pipette well and electrode 192 is in electrical contact with the fluid in bath well 198. Pipette well 196, channel 204a, and orifice 204 together form the integrated micropipette.

Cells may be introduced into bath well 198 through an opening 200 in cover plate 194. This opening may also be used to dispense pharmaceuticals or other fluids into bath well 198. Fluids can also be withdrawn or exchanged through orifice 200. Fluids can be dispensed into, withdrawn, or exchanged from pipette well 196 through orifice 202 in cover plate 194. In addition, suction may be applied to pipette well 196 through opening 202 to draw a cell from bath cavity 198 into orifice 204. Although electrodes 190 and 192 are shown to be located on cover plate 194 other locations within bath well 198 and pipette well 196 or within the subsurface channel are possible. For example, one electrode can be disposed in the channel and the other electrode can be disposed in a recess, such as a second subsurface channel or other space, placed in communication with the bath well. In addition, it is not necessary that either or both electrodes be integrated. Although integration enhances the functionality of the device, the electrodes could be inserted into the pipette well and the bath well through the cover plate orifices 202 and 200 respectively, or in any other manner.

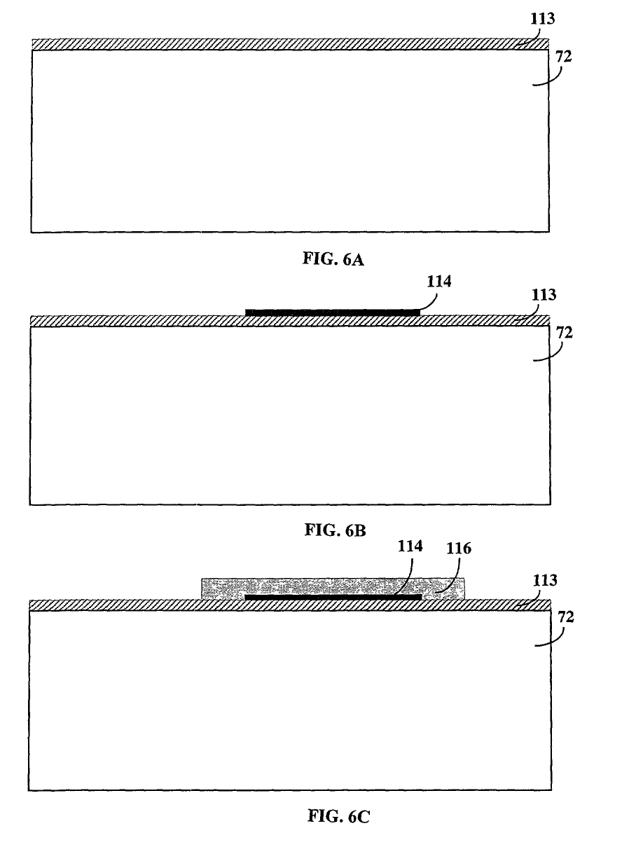

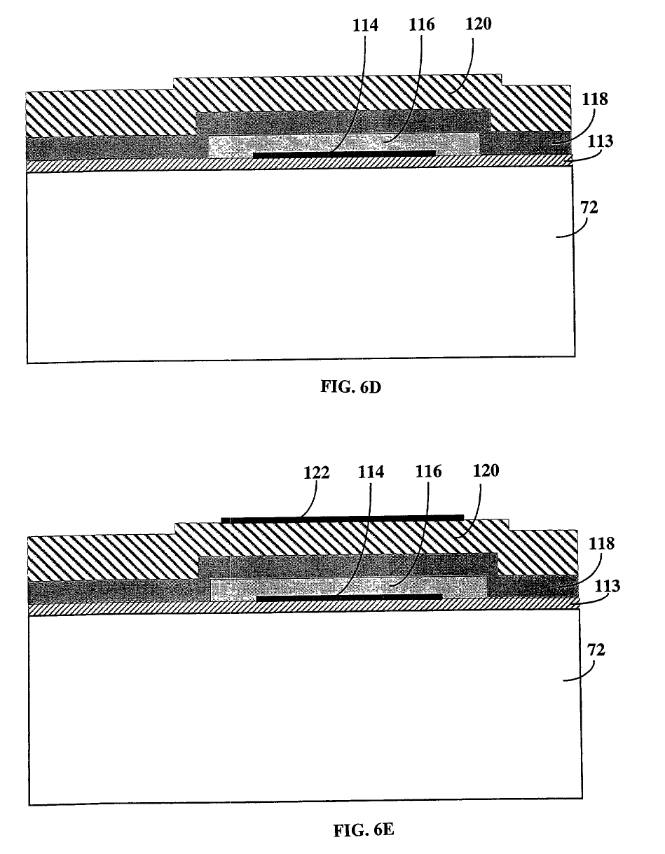

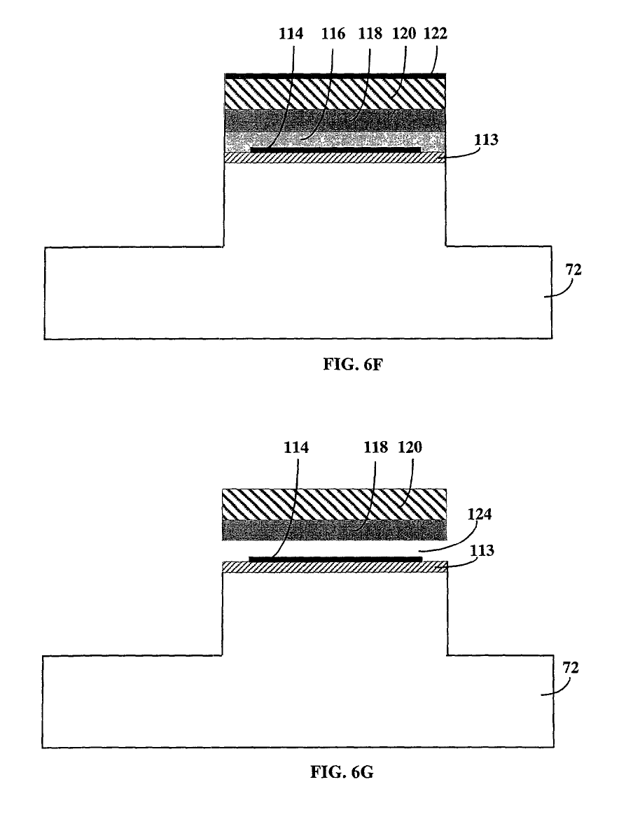

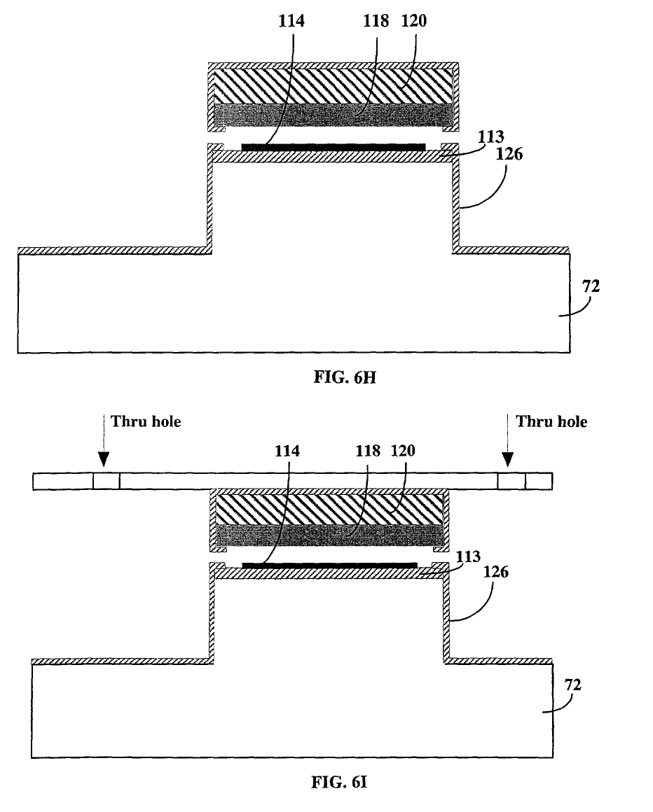

FIGS. 6a-6i illustrate a second preferred method of fabricating a microdevice in accordance with the preferred embodiment. In FIG. 6a, a biocompatible layer 113, such as SiO₂, polyimide, or oxynitride is grown or deposited on the substrate 72. Layer 113 will form one wall of the interior of the pipette and is used to ensure that the interior is made only of bio-compatible materials. The surface of substrate 72 must be coated with an appropriate substance since bare silicon can be harmful to cells, thus limiting the ability to perform analyses on the cells. However, layer 113 can be omitted if the substrate is bio-compatible.

In FIG. 6b, titanium silver (Ti/Ag) or another bio-compatible conductor such as titanium platinum (Ti/Pt) 114 is grown or deposited and selectively patterned using either a dry or a wet etching process. The conductor must be able to exchange ions with the fluid in the well. A sacrificial layer 116 made of photoresist or another polymer or other substance is then deposited and patterned (FIG. 6c). The sacrificial layer is preferably about 0.5 μm to 3 μm thick, although other thicknesses may be used.

In FIG. 6d about 2.5 μm of parylene 118 and a thicker layer of polyimide 120 are deposited. Although polyimide can be patterned like a photoresist, in the preferred embodiment the polyimide will be developed and baked without patterning. Layer 120 is the main structural layer for the channel and should be strong enough to prevent collapse of the channel when a cover, such as a glass plate, is bonded to the top of the wafer. Layer 118 has been included to prevent the solvents in the polyimide from dissolving sacrificial layer 116. Layer 118 can also be SiO₂, Si₃N₄, oxynitride, or another bio-compatible material that can be deposited at low temperatures (compatible with the polymer sacrificial layer) and patterned using dry etching.

In FIG. 6e, a masking layer 122 is evaporated and patterned. The masking layer 122 may be aluminum, Ti/Ag, or another substance. The masking layer 122 serves as a mask for the next etch step (shown in FIG. 6f), preferably a dry etch, which must etch (with vertical sidewalls) the polyimide 120, parylene 118, sacrificial layer 116, bio-compatible layer 113, and the substrate 72. This etch defines the trench which will be filled with fluid, and into which the cells or other biological material will be dispensed. This etch should not substantially etch the masking layer 122, and preferably it should not etch the masking layer 122 at all.

Following the trench etch, as shown in FIG. 6f, masking layer 122 is removed, preferably in a wet etchant but optionally by a dry etching process. For example, if layer 122 is aluminum then a wet etch can be used. It may be necessary to protect the bond pad areas during the removal of the masking layer 122. This can be accomplished using a photoresist or other materials. Sacrificial layer 116 is then removed as shown in FIG. 6g. If layer 116 is a photoresist this can be accomplished by immersing the device in acetone. Removal of layer 116 forms the pipette channel 124. The process continues, as shown in FIG. 6h, with the deposition of a bio-compatible coating layer 126 on all exposed surfaces. Layer 126 will coat the pipette orifice opening and will coat the inside of the pipette near the orifice. Layer 126 renders the exposed substrate surface and all other exposed surfaces which it coats bio-compatible. For most applications, layer 126 is preferably comprised of SiO2 since the plasma membrane of many cells will form a gigaseal to a SiO2 surface. However, other materials can be used, especially for cell lines that may more reliably form gigaseals to other materials. If another material is used, it can be sputtered or otherwise deposited on top of layer 126. During the deposition of layer 126 the bond pad areas are preferably masked or otherwise shielded to prevent deposition on top of the bond pads.

The final step is the optional bonding of a glass plate or other cover plate over the device. The cover plate can contain one or more holes through which fluid and cells can be dispensed. Once again conventional electrical or mechanical devices can be integrated with the pipette using known procedures. Such devices can be formed on the substrate first in a conventional manner and then masked prior to etching.

The thickness of the sacrificial layer 116 and bio-compatible coating layer 126 (FIGS. 6h and 6i) determine the final orifice height of the pipette. For example, a 2 μm thick sacrificial layer and a 0.25 μm thick coating layer will yield an orifice height of about (2 μm−2×0.25 μm=)1.5 μm. The orifice width is determined by the mask layout dimension and the thickness of the coating layer.

As shown in FIGS. 6h and 6i, the combined thickness of layers 120, 118, 116, 114, and 113, and the depth of the substrate etch, determine the depth of the recess and the vertical position of the orifice. For example, if the combined thickness of layers 120, 118, 116, 114, and 113 approximately equals the depth of the substrate etch, the orifice will be located in the center of the recess wall. However, if the combined thickness of the deposited layers is reduced and the silicon etch depth increased, the orifice will be located closer to the surface of the substrate. Thus, by choosing the thickness of the deposited layers and substrate etch depth the orifice vertical position can be adjusted as shown in FIGS. 1b through 1g.

Contact to electrode 114 can be made by bringing the electrode materials out under parylene layer 118 and polyimide layer 120 to bond pads (not illustrated). When this method is used, the bond pads should be protected (covered) during the deposition of the coating layer 126 to prevent deposition in those areas. A bath well electrode can be made by forming a pipette on another wall of the bath well. This pipette would not connect to any other well or fluid reservoir. The electrode contained in this channel will be in contact with the bath fluid. This electrode can also be brought out to a bond pad.

FIG. 7 illustrates one preferred method of moving and positioning cells near the opening of an integrated micropipette. This preferred embodiment employs a hydrostatic pressure gradient similar to the one experienced by red blood cells in the veins of the human body. The hydrostatic pressure gradient is created by applying suction through suction orifice 68, which is an orifice that is large enough to generate the required flow but small enough to prevent the passage of a moving cell. Applying suction through orifice 68 means applying a pressure that is less in absolute value than absolute pressure in bath well 50. The hydrostatic pressure gradient can also be created by pressurizing bath well 50 such that cells and fluid are drawn to suction orifice 68. Combination of suction and pressure can also be used. Preferably, orifice 68 is located near one or more of the integrated pipette orifices 60, 62, 64, and 66 of pipettes 56, 58, 54, 52 respectively. Thus, when suction is applied by a pressure source, cells located in bath well 50 will drift toward the large suction orifice and become trapped against the suction orifice 68. As the cells are drifting toward suction orifice 68, or once they are trapped against the orifice, a small amount of suction may be applied through any of the pipettes to move the cell slightly such that a gigaseal can be formed between the corresponding pipette orifice and the cell.

The device shown in FIG. 7 can also have a cover plate, although the cover plate is optional. The suction necessary to create the pressure gradient can be applied through holes in the optional cover plate. Alternately, vertical access holes can be formed in the substrate, and suction can be applied through these openings. The suction mechanism of the embodiment illustrated in FIG. 7 can be used in connection with other embodiments and designs by forming a suction orifice proximate the pipette orifice and coupling a pressure source thereto.

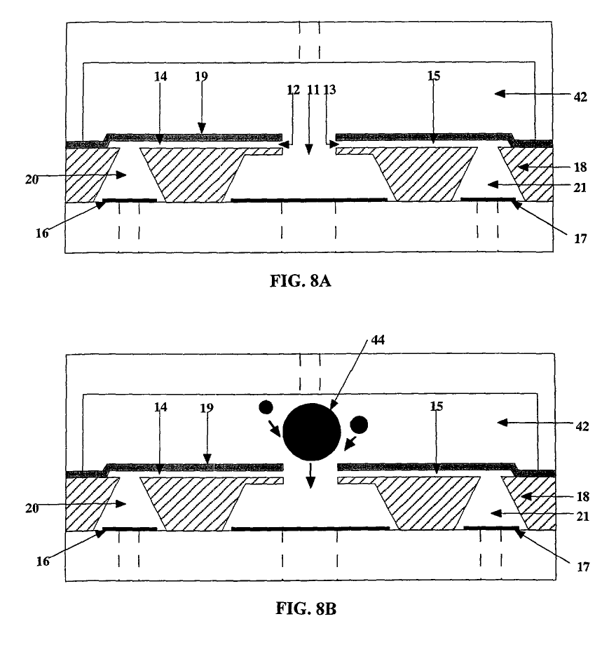

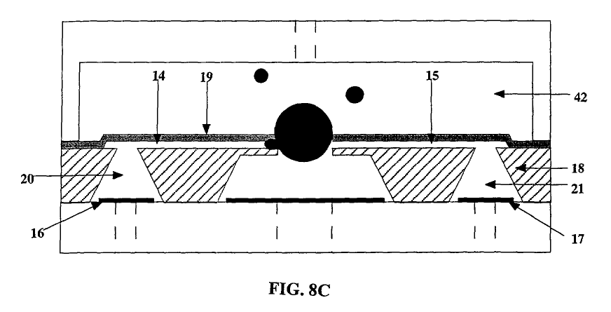

Other embodiments of the invention are illustrated in FIGS. 8a through 8c. The embodiment shown in FIG. 8a illustrates a device which uses a hydrostatic pressure gradient to move and position cells. The embodiment shown in FIG. 8a also illustrates the use of vertical ports or through holes to access the pipette fluid and the bath fluid. Referring to FIG. 8a, the microchip structure preferably includes a suction orifice 11, one or more pipette orifices 12 and 13, one or more channels 14 and 15, and conductive electrodes 16 and 17. The suction orifice 11 is an opening of any shape, such as a circle or oval formed in substrate 18. Each pipette orifice 12 and 13 is preferably smaller than, the suction orifice and is preferably about 0.5 μm to 3 μm in diameter. Each pipette orifice serves as an opening to a channel that comprises a small gap between substrate 18 or a first structural layer and another structural layer 19. Each pipette orifice together with the adjoining channel form one integrated micropipette. This embodiment can also be fabricated using MEMS technology.

Each channel preferably contains fluid that can be added, removed or replaced via an access port. For example, the fluid in channel 14 can be replaced through access port 20 and the fluid in channel 15 can be replaced via access port 21. Furthermore, each channel is preferably designed to have a shape that achieves low access resistance for low-noise recording. For example, the channel may be narrow at the tip (i.e., the location of the pipette orifice) and wider at the base near the access port.

Hydrostatic pressure may be applied to cells in bath well 42 to move them toward orifice 11 by flowing fluid from the bath well through orifice 11 using a pressure source. Such hydrostatic pressure can be applied by either pressurizing bath well 42 or by applying suction from bottom of orifice 11 or by both suction and pressure. The fluid flow mobilizes cells 44 drawing them closer to orifice 11 using a pressure source (FIG. 8b). The diameter of orifice 11 is smaller than the diameter of cell 44 thus the cell cannot pass through the orifice. As a cell nears orifice 11, or once the cell has become trapped against orifice 11, gentle suction may be applied through a pipette channel. This suction moves the cell slightly toward the pipette orifice and then stretches a portion of the cellular membrane into the channel. The exterior of the cellular membrane will then seal to the interior of the channel creating a gigaseal.

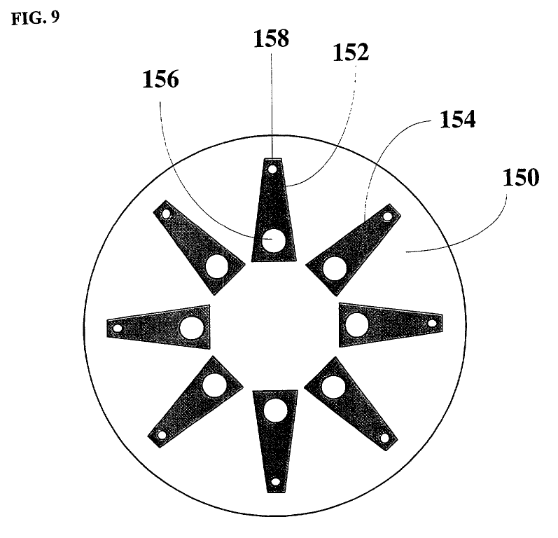

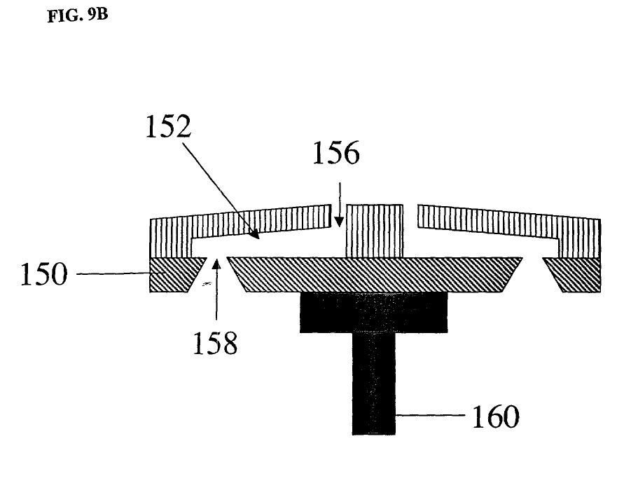

Although it is preferred that the integrated pipettes be positioned in a horizontal manner so that they are parallel to the substrate surface, an alternate embodiment allows a vertical or substantially vertical pipette. One such embodiment is illustrated in FIGS. 9a and 9b. Referring to FIG. 9a, which shows such embodiment from above, a substrate 150 defines a microdevice having a plurality of guiding channels such as 152 and 154. Each guiding channel includes a larger receiving opening 156 and a smaller pipette opening (orifice) 158.

One possible sectional view of the embodiment illustrated in FIG. 9a is provided in profile in FIG. 9b. Referring to FIG. 9b, the substrate 150 is coupled to a rotating shaft 160, or other rotational mechanism. Cells or materials to be analyzed, as well as drugs or other reagents to be introduced, are inserted into a larger opening 156. The opening 156 can also be placed on the bottom substrate. Centrifugal force, generated by rotating the device, pushes the cell through guiding channel 152 to the pipette opening 158. The pipette opening 158 can also be placed on the top cover. The cell is drawn partially into the pipette opening so that a gigaseal is formed between the interior wall of the pipette and the cell membrane.

The horizontal integrated pipette avoids or minimizes many of the limitations of the prior art. Traditional glass micropipettes have a large (>1 MΩ) access resistance. The horizontal pipette facilitates the integration of an electrode reducing or eliminating the glass micropipette shank resistance. In addition, the geometry of the tip opening can be precisely controlled to help minimize the access resistance while forming a reliable gigaohm seal. Traditional glass micropipettes also have a large pipette capacitance. Since the geometry and position of the integrated pipette can be defined by photolithography, the pipette capacitance can be virtually eliminated. Only a limited set of materials is available for pipette fabrication using the heat and pull method. Unlike the heat and pull method of conventional capillary fabrication, the integrated pipette is fabricated using integrated circuit and MEMS fabrication technologies which allow for a much broader selection of materials both for the structural part of the pipette and for the coating on the tip of the pipette. For example, MEMS micro pipettes can be made from single crystal silicon, polycrystalline silicon, quartz, silicon nitride, and biocompatible polymers such as parylene and PDMS. In addition, the tip coating material can be selected independently, thus allowing the tip coating to be tailored to the cell line under test for better seals and less interference with cell physiology. Hence, the desired pipette geometry along with the desired material properties can be attained.

Traditional glass micropipettes must be coated near their tips with an elastomer to nullify the stray capacitance and associated noise. The integrated pipette capacitance is preferably negligible. Thus, the elastomer coating is unnecessary. Traditional glass micro pipettes must be fire-polished. Fire-polishing is not necessary with the invention. The orifice can be thus fabricated to the desired smoothness. Traditional glass micro pipettes contain a large volume of fluid. The pipette volume of the invention can be reduced to a fraction of the volume of 20 μm spherical cell. Since manual macro handling of the pipette is not required, the minimum size of the integrated pipette is limited not by presence of a several centimeter long shank but rather by MEMS fabrication technology in the order of several micrometers.

It is also difficult to rapidly exchange the fluid in a traditional glass micro pipette. The horizontal integrated micro pipette is fabricated on the surface of the substrate thus facilitating the integration of microfluidic pumps and valves for on-chip precise fluid handling to rapidly exchange the pipette fluid. Further, it is difficult to rapidly exchange the extra cellular solution in the conventional patch clamp setup. Integrated on-chip microfluidics can also be used to exchange the extra cellular solution. The integrated horizontal pipette facilitates the automatic positioning of cells and the automatic formation of the gigaseal. The integrated pipette will eliminate the need for pipette pullers, micromanipulators, and preferably an optical microscope. Shielding can also be integrated eliminating the need for a Faraday cage. The pipette can also be integrated with electronics. Further, the optional use of a centrifuge mechanism for moving cells renders the invention more reliable than conventional devices.

The many features and advantages of the invention are apparent from the detailed specification. Further, since numerous modifications and variations will readily occur to those skilled in the art, it is not desired to limit the invention to the exact construction and operation illustrated and described. Accordingly, all suitable modifications and equivalents may be included within the scope of the invention as defined by the appended claims and legal equivalents.

What is claimed is:

1. A micro-fluidic device adapted to accomplish a procedure using fluid, said device comprising:
a substrate having a thickness direction and a substantially planar surface extending in a lengthwise direction that is substantially perpendicular to the thickness direction;
a well formed in said substrate and defining a sidewall and a bottom surface;
a channel having an internal surface formed in said substrate below the substantially planar surface and extending substantially in said lengthwise direction, said channel being in communication with said well at one end of said channel to thereby define an orifice in said sidewall, whereby fluid in said well can be drawn into said orifice.

2. A device as recited in claim 1, wherein said sidewall extends substantially in said thickness direction.

3. A device as recited in claim 2, wherein said well has a predetermined depth and said orifice is defined in said sidewall at a position independent of the predetermined depth.

4. A device as recited in claim 1, further comprising a coating disposed on at least one of said sidewall and said internal surface at a position defining said orifice.

5. A device as recited in claim 4, wherein said coating comprises a material having an affinity to a liquid to be disposed in said channel.

6. A device as recited in claim 4, wherein said coating comprises a material having an affinity to a bilayer lipid membrane.

7. A device as recited in claim 4, wherein said coating comprises a material having an affinity to a cell membrane.

8. A device as recited in claim 4, wherein said coating comprises a biocompatible material.

9. A device as recited in claim 4, wherein said coating comprises an electrically insulating material.

10. A device as recited in claim 1, further comprising a coating on at least one of said sidewall and said bottom surface.

11. A device as recited in claim 10, wherein said coating comprises a material having an affinity to a liquid to be disposed in said well.

12. A device as recited in claim 10, wherein said coating comprises a material having an affinity to a bilayer lipid membrane.

13. A device as recited in claim 10, wherein said coating comprises a material having an affinity to a cell membrane.

14. A device as recited in claim 10, wherein said coating comprises a biocompatible material.

15. A device as recited in claim 10, wherein said coating comprises an electrically insulating material.

16. A device as recited in claim 1, wherein said channel has an interior volume that is less than about the volume of a 20 μm diameter sphere.

17. A device as recited in claim 1, wherein said orifice has a diameter that is in the range of less than 0.5 μm to 100 μm inclusive.

18. A device as recited in claim 1, further comprising a cover plate disposed on said substrate to cover said well.

19. A device as recited in claim 18, wherein said cover plate comprises a nonconducting material.

20. A device as recited in claim 18, wherein said cover plate comprises a transparent material.

21. A device as recited in claim 18, further comprising an electrode integrally formed on the cover plate.

22. A device as recited in claim 1, further comprising a mechanism configured to move fluid through the channel, said mechanism being formed integrally on said substrate.

23. A device as recited in claim 22 wherein said mechanism comprises at least one of an actuator, a suction device, a pump, a valve, and a mixer.

24. A device as recited in claim 1, further comprising electrical components formed integrally on said substrate.

25. A device as recited in claim 24, wherein said electrical components comprise at least one of a sensor, a heater, a ground plane, and an amplifier.

26. A device as recited in claim 1, wherein said procedure is a patch clamping procedure.

27. A device as recited in claim 1, wherein said procedure is a procedure for extracting contents of a cell.

28. A device as recited in claim 1, wherein said procedure is a procedure for introducing a substance into a cell.

29. A device as recited in claim 28, wherein said procedure is an in vitro fertilization procedure.

30. A device as recited in claim 1, wherein said procedure is a procedure for forming stable bilayer lipid membranes.

31. A device as recited in claim 1, wherein said procedure is an electrospray ionization procedure.

32. A device as recited in claim 1, wherein plural channels are formed in said substrate and plural wells are defined in said substrate each of said plural channels communicating with a corresponding one of said plural wells to define a corresponding orifice.

33. A device as recited in claim 32, wherein each of said plural channels extends radially from a central point of symmetry defined on said substrate.

34. A device as recited in claim 1, wherein said substrate comprises a nonconducting material.

35. A device as recited in claim 1, wherein said substrate comprises one of glass and a semiconductor material.

36. A device as recited in claim 1, wherein said well is a bath well and further comprising a pipette well in communication with said channel, said pipette well, said channel and said orifice constituting a pipette.

37. A device as recited in claim 36, further comprising a cover plate disposed over said bath well and said pipette well.

38. A device as recited in claim 37, wherein said cover plate comprises a nonconducting material.

39. A device as recited in claim 37, wherein said cover plate comprises a transparent material.

40. A device as recited in claim 37, further comprising of first electrode disposed on a portion of said cover plate disposed over said bath well.

41. A device as recited in claim 37, further comprising a second electrode disposed on a portion of said cover plate disposed over said pipette well.

42. A device as recited in claim 36, further comprising means for moving cells contained in said bath well towards said orifice.

43. A device as recited in claim 42, wherein said means for moving includes a hydrostatic pressure source.

44. A device as recited in claim 43, wherein said means for moving further comprises a suction orifice positioned proximate said orifice and coupled to said hydrostatic pressure source.

45. A device as recited in claim 43, wherein said hydrostatic pressure source is a source of a smaller absolute pressure than pressure in said bath well.

46. A device as recited in claim 1, further comprising a first electrode disposed inside said channel.

47. A device as recited in claim 46, wherein said first electrode is disposed proximate the orifice.

48. A device as recited in claim 1 further comprising a second electrode associated with said well.

49. A device as recited in claim 48, further comprising a recess formed in said substrate in communication with said well, and wherein said electrode is disposed in said recess.

50. A device as recited in claim 49, wherein said recess is a subsurface channel.

51. A method of manufacturing a micro-fluidic device adapted to accomplish a procedure using fluid, said method comprising:
(a) forming a first trench having a bottom surface in the substrate;
(b) forming a first structural layer on the bottom surface;
(c) forming a sacrificial layer on the first structural layer;
(d) forming a second structural layer on the sacrificial layer;
(e) forming second and third trenches with at least a portion of the first structural layer, the second structural layer and the sacrificial layer extending therebetween;
(f) removing the sacrificial layer to define a channel extending from the second trench to the third trench.

52. A method as recited in claim 51, wherein, in said step (e), the second trench is formed to define a pipette well, the third trench is formed to define a bath well having a sidewall, wherein the channel defines an orifice in the sidewall and wherein the channel, the second trench, and the orifice define a pipette.

53. A method as recited in claim 51, wherein said step (a) comprises forming a masking layer on the substrate and etching through the masking layer.

54. A method as recited in claim 51, wherein, said step (b) comprises forming a structural layer on the substrate to substantially fill the first trench and removing portions of the structural layer to leave a structural layer film on the bottom surface.

55. A method as recited in claim 51, further comprising performing a planarization process on the substrate between steps (d) and (e) to define a flat surface on the substrate.

56. A method as recited in claim 55, wherein said planarization process comprises polishing.

57. A method as recited in claim 52, wherein said substrate has a thickness direction and said sidewall extends substantially in said thickness direction.

58. A method as recited in claim 52, wherein said steps (b), (c), and (d) each comprise forming layers of a predetermined thickness to define an orifice at a desired position along the sidewall.

59. A method as recited in claim 52, further comprising forming a coating on at least one of the sidewall and an interior surface defining the channel at least at a position defining the orifice.

60. A method as recited in claim 59, wherein the coating comprises a material having an affinity to a liquid to be disposed in the channel.

61. A method as recited in claim 59, wherein the coating comprises a material having an affinity to a bilayer lipid membrane.

62. A method as recited in claim 59, wherein the coating comprises a material having an affinity to a cell membrane.

63. A device as recited in claim 59, wherein said coating comprises a biocompatible material.

64. A device as recited in claim 59, wherein said coating comprises an electrically insulating material.

65. A method as recited in claim 52, further comprising forming a coating on at least one of the sidewall and bottom surface.

66. A method as recited in claim 65, wherein the coating comprises a material having an affinity to a liquid to be disposed in the well.

67. A method as recited in claim 65, wherein the coating comprises a material having an affinity to a bilayer lipid membrane.

68. A method as recited in claim 65, wherein the coating comprises a material having an affinity to a cell membrane.

69. A device as recited in claim 65, wherein said coating comprises a biocompatible material.

70. A device as recited in claim 65, wherein said coating comprises an electrically insulating material.

71. A method as recited in claim 52, wherein the channel and pipette well in combination defines an interior volume that is less than about the volume of a 20 μm diameter sphere.

72. A method as recited in claim 52, wherein the orifice has a diameter that is in the range of less than 0.5 μm to 100 μm inclusive.

73. A method as recited in claim 52, further comprising disposing a cover plate over the pipette well and the bath well.

74. A method as recited in claim 73, wherein said cover plate comprises a nonconducting material.

75. A method as recited in claim 73, wherein said cover plate comprises a transparent material.

76. A method as recited in claim 73, further comprising forming a first electrode on a portion of the cover plate disposed over the pipette well.

77. A method as recited in claim 73, further comprising forming a second electrode on a portion of the cover plate disposed over the bath well.

78. A method as recited in claim 51, further comprising integrally forming on the substrate a mechanism configured to move fluid through the channel.

79. A method as recited in claim 78, wherein said step of integrally forming comprises forming at least one of an actuator, a pump, a suction device, a valve, and a mixer.

80. A method as recited in claim 51, further comprising integrally forming on the substrate electrical components.

81. A method as recited in claim 80, wherein said step of integrally forming comprises forming at least one of a sensor, a heater, a ground plane, and an amplifier.

82. A method as recited in claim 51, wherein said procedure is a patch clamping procedure.

83. A method as recited in claim 51, wherein said procedure is a procedure for extracting contents of a cell.

84. A method as recited in claim 51, wherein said procedure is a procedure for introducing a substance into a cell.

85. A method as recited in claim 84, wherein said procedure is an in vitro fertilization procedure.

86. A method as recited in claim 51, wherein the procedure is a procedure for forming stable bilayer lipid membranes.

87. A method as recited in claim 51, wherein the procedure is an electrospray ionization procedure.

88. A method as recited in claim 51, wherein each of said steps (a) through (f) are performed plural times to define plural channels and plural bath wells in said substrate, each of said channels communicating with a corresponding one of said bath wells to define a corresponding orifice.

89. A method as recited in claim 88, wherein the plural channels and plural wells are formed simultaneously using a lithography process.

90. A method as recited in claim 88, wherein each of said plural channels extends radially from a central point of symmetry defined on the substrate.

91. A method as recited in claim 51, wherein the substrate comprises one of glass and a semiconductor material.

92. A method as recited in claim 51, wherein the substrate comprises a nonconducting material.

93. A method as recited in claim 51, further comprising disposing a first electrode inside said channel.

94. A method as recited in claim 93, wherein said first electrode is disposed proximate the orifice.

95. A method as recited in claim 93, further comprising disposing a second electrode in association with the third trench.

96. A method as recited in claim 95, wherein said second electrode is disposed in a recess communicating with the third trench.

97. A method as recited in claim 96, wherein said recess is a subsurface channel.

98. A method of manufacturing a micro-fluidic device adapted to accomplish a procedure using fluid, said method comprising:
(a) forming a biocompatible layer on a substrate;
(b) forming an electrode on the biocompatible layer;
(c) forming a sacrificial layer over the electrode;
(d) forming at least one structural layer on the sacrificial layer;
(e) forming a first trench and a second trench in the substrate, said first trench having a sidewall defined at least by the structural layer and a bottom surface; and
(f) removing the sacrificial layer to define a channel providing communication between the first trench and the second trench and defining an orifice on the sidewall.

99. A method as recited in claim 98, wherein said step (d) comprises forming a layer of parylene and forming a layer of polyimide over the layer of parylene.

100. A method as recited in claim 98, wherein said step (e) comprises forming a masking layer over the structural layer, and selectively removing any structural layer not covered by the masking layer.

101. A method as recited in claim 98, wherein the first trench is formed to define a bath well.

102. A method as recited in claim 101, wherein the second trench defines a pipette well in communication with the channel, and wherein the channel, the pipette well, and the orifice define a pipette.

103. A method as recited in claim 98, wherein said substrate has a thickness direction and said step (e) comprises defining the sidewall to extend substantially in the thickness direction.

104. A method as recited in claim 98, further comprising forming a coating on at least one of the sidewall and an internal surface of the channel at a position defining the orifice.

105. A method as recited in claim 104, wherein the coating comprises a material having an affinity to a liquid to be disposed in the channel.

106. A method as recited in 104, wherein the coating comprises a material having an affinity to a bilayer lipid membrane.

107. A method as recited in claim 104, wherein the coating comprises a material having an affinity to a cell membrane.

108. A method as recited in claim 104, wherein the coating comprises a biocompatible material.

109. A method as recited in claim 104, wherein the coating comprises an electrically insulating material

110. A method as recited in claim 98, wherein the channel and the second trench in combination defines an interior volume that is less than about the volume of a 20 μm diameter sphere.

111. A method as recited in claim 98, wherein the orifice has a diameter that is in the range of less than 0.5 μm to 100 μm inclusive.

112. A method as recited in claim 98, further comprising forming a coating on at least one of the sidewall and an interior surface defining the channel at least at a position defining the orifice.

113. A method as recited in claim 112, wherein the coating comprises a material having an affinity to a liquid to be disposed in the well.

114. A method as recited in claim 112, wherein the coating comprises a material having an affinity to a bilayer lipid membrane.

115. A method as recited in claim 112, wherein the coating comprises a material having an affinity to a cell membrane.

116. A method as recited in claim 112, wherein said coating is a biocompatible material.

117. A method as recited in claim 112, wherein said coating is an electrically insulating material.

118. A method as recited in claim 102, further comprising disposing a cover plate over the first trench and the second trench.

119. A method as recited in claim 118, wherein said cover plate comprises a nonconductive material.

120. A method as recited in claim 118, wherein said cover plate comprises a transparent material.

121. A method as recited in claim 98, further comprising integrally forming on the substrate a mechanism configured to move fluid through the channel.

122. A method as recited in claim 121, wherein said step of integrally forming comprises forming at least one of an actuator, a pump, a suction device, a valve, and a mixer.

123. A method as recited in claim 98, further comprising integrally forming on the substrate electrical components.

124. A method as recited in claim 123, wherein said step of integrally forming comprises forming at least one of a sensor, a heater, a ground plane, and an amplifier.

125. A method as recited in claim 98, wherein the procedure is a patch clamping procedure.

126. A method as recited in claim 98, wherein the procedure is a procedure for extracting contents of a cell.

127. A method as recited in claim 98, wherein the procedure is a procedure for introducing a substance into a cell.

128. A method as recited in claim 127, wherein the procedure is an in vitro fertilization procedure.

129. A method as recited in claim 98, wherein the procedure is a procedure for forming stable bilayer lipid membranes.

130. A method as recited in claim 98, wherein the procedure is an electrospray ionization procedure.

131. A method as recited in claim 98, wherein each of said steps (a) through (f) are performed plural times to define plural channels and plural wells in said substrate, each of the channels communicating with a corresponding one of the wells to define a corresponding orifice.

132. A method as recited in claim 131, wherein the plural channels and plural wells, are formed simultaneously using a lithography process.

133. A method as recited in claim 131, wherein each of said plural channels extends radially from a central point of symmetry defined on the substrate.

134. A method as recited in claim 98, wherein the substrate comprises one of glass and a semiconductor material.

135. A method as recited in claim 98, wherein the substrate comprises a nonconducting material.

136. A method of moving biological cells to a desired position to facilitate performance of a procedure on the cells, said method comprising:
disposing a liquid containing at least one biological cell in communication with a channel formed in a substrate;
rotating said substrate about an axis to create a centripetal force directed toward the axis;
permitting at least one cell to travel through the channel to be positioned against an orifice in response to the centripetal force.

137. A method as recited in claim 136, wherein the axis extends substantially perpendicular to a planar surface of the substrate and the channel extends substantially parallel to the planar surface.

138. A method as recited in claim 137, further comprising the step of forming a gigaohm seal between at least one cell and the orifice.

139. A method as recited in claim 136, wherein said channel is a subsurface channel.

140. A method as recited in claim 136, wherein said channel defines a portion of a micro-fluidic device.

141. A micro-fluidic device adapted to accomplish a procedure using fluid, said device comprising:
a rotational member;
a body coupled to the rotational member to be rotated about a central portion thereof;
a guiding channel formed in the body;
means for introducing a fluid having at least one cell into said guiding channel at a first radial position with respect to the central portion; and
a pipette orifice coupled to said guiding channel at a second radial position with respect to the central portion, said second radial position being further from said central portion than said first radial position, whereby rotation of said body about said central portion causes at least one cell in fluid in said guiding channel to flow towards said pipette orifice to thereby position the at least one cell against the orifice.

142. A device as recited in claim 141, further comprising a coating disposed on a surface of said guiding channel at least at a position defining said pipette orifice.

143. A device as recited in 142, wherein said coating is a biocompatible material.

144. A device as recited in claim 142, wherein said coating comprises a material having an affinity to a liquid to be disposed in said guiding channel.

145. A device as recited in claim 142, wherein said coating comprises a material having an affinity to a bilayer lipid membrane.

146. A device as recited in claim 142, wherein said coating comprises a material having an affinity to a cell membrane.

147. A device as recited in claim 142, wherein said coating is an electrically insulating material.

148. A device as recited in claim 141, wherein said orifice has a diameter that is in the range of less than 0.5 μm to 100 μm inclusive.
